(19) United States
(12) Patent Application Publication
(10) Pub. No.: US 2025/0243738 A1
(43) Pub. Date: Jul. 31, 2025

(54) Systems and Methods for Data Acquisition from Valve Assemblies

(71) Applicant: Force Pressure Control, LLC, Seguin, TX (US)

(72) Inventors: Jacob Startz, Seguin, TX (US); Dustin Nesloney, Orange Grove, TX (US)

(73) Assignee: Force Pressure Control, LLC, Seguin, TX (US)

(21) Appl. No.: 19/003,002

(22) Filed: Dec. 27, 2024

Related U.S. Application Data
(60) Provisional application No. 63/627,276, filed on Jan. 31, 2024.

(51) Int. Cl. E21B 43/26; F16K 31/122; F16K 37/00

(52) U.S. Cl. CPC E21B 43/2607; F16K 31/122; F16K 37/005; F16K 37/0041; F16K 37/0066

(57) ABSTRACT

The present invention comprises a valve assembly with load, pressure, temperature, and other sensors for monitoring the operation of the valve assembly. The sensors may interface with the hydraulic cylinder and the cavity surrounding flow bore of the valve assembly to acquire data related to changes in load and pressure. These changes may be analyzed to determine if the valve assemblies are operating properly or improperly and need to be disassembled and replaced. Upon initial operation of the valve assembly, baseline readings related to load and pressure should be acquired to compare with future load and pressure readings during operation.

### PRIORITY CLAIM

The present application claims priority to and incorporates by reference Provisional Patent Application No. 63/627,276, titled “Systems and Methods for Data Acquisition from Valve Assemblies,” that was filed on Jan. 31, 2024.

### TECHNICAL FIELD

The present invention relates generally to acquiring data related to the operation of a valve, and more specifically, a data acquisition system for a valve assembly that enables an operator to assess the operation of the components of the valve.

### BACKGROUND OF THE INVENTION

Valves are used in numerous industries to transport and control the flow of water or aqueous solutions, including the oil and gas industry. These valves are designed to start, stop, and even control the flow of liquids through the system. In the oil and gas industry, these liquids may include water, oil mixtures, frac fluids, or other liquid solutions that need to be transported to a well and into the ground or extracted from the ground. Grease, sand, or other foreign materials within the frac fluid may migrate from the valve passageway to the valve cavity or cavities to cause problems with the valve. With conventional valve assemblies in the oil and gas industry, an operator must disassemble, clean, add grease, and repair the valve assembly after each stage or use. And if the valve assembly is designed for multiple uses, there is currently no method of system for analyzing the valve assembly to determine if it does need adjustment or repair. A data acquisition system to assess the functioning of a valve assembly may enable an operator to determine whether a valve assembly needs to be examined, cleaned, or repaired before repeat usage.

### BRIEF SUMMARY OF THE INVENTION

The present invention comprises a data acquisition system for a valve assembly. In some embodiments, this valve assembly may include a gate and a seat assembly, wherein the seat assembly activates and deactivates a seal with the gate to seal a flow bore cavity from a cavity surrounding the seat assembly. Depending upon the operation of the gate/seat seal, the pressures within the flow bore cavity should be isolated from the cavity surrounding the seat assembly. Thus, pressure readings within the flow bore cavity and the cavity surrounding the seat assembly may indicate how the gate and the seat assembly are operating. Analyzing and comparing these pressure readings may allow an operator to assess the operation of the valve assembly, and if the valve assembly continues to operate properly, then the valve may not need to be disassembled and repaired after each stage or use. Pressure sensors may be attached to these cavities in the valve to obtain these measurements. A hydraulic cylinder may be used to open and close the gate of the valve, wherein the seat assembly should activate and deactivate the gate/seat seal during this process. Pressure and load measurements within the hydraulic cylinder may be analyzed and compared to assess whether the hydraulic cylinder and the corresponding gate/seat seal are operating properly. Pressure and load sensors may be attached to the hydraulic cylinder to obtain these measurements.

Baseline measurements should be recorded at the outset of operation of the valve for comparison during operation. Differences and deviations in these measurements may indicate problems or issues with the valve that need to be repaired. Temperature affects pressure measurements and may affect load measurements, so external and internal temperature readings may be factored into this analysis as well.

### BRIEF DESCRIPTION OF THE DRAWINGS

For a more complete understanding of the present invention, reference is now made to the following descriptions taken in conjunction with the accompanying drawing, in which:

FIG. 1 shows a front view of a traditional gate valve assembly;

FIG. 2 shows an exploded view of a traditional gate valve assembly;

FIG. 3 shows a front view of a gate valve assembly according to certain embodiments of the present invention;

FIGS. 4A and 4B shows a cross-section view and an internal view of a hydraulic cylinder assembly according to certain embodiments of the present invention;

FIG. 5 shows a cross-section view of a gate valve assembly according to certain embodiments of the present invention;

FIG. 6 shows a block diagram of a data acquisition system for a single valve according to certain embodiments of the present invention; and

FIG. 7 shows a block diagram of a data acquisition system for multiple valves according to certain embodiments of the present invention.

### DETAILED DESCRIPTION OF THE INVENTION

In general, valves or valve assemblies are used to control the movement of liquids, fluids, solutions, water, or other fluids at high pressures. Valves or valve assemblies may be used in various industries in numerous implementations, including but not limited to, the oil and gas industry. Within the oil and gas industry, there are numerous types of valves or valve assemblies that may use the present invention. The present invention is not limited to any specific valve or valve assembly and may be used in various industries and implementations. The figures and descriptions herein disclose a gate valve assembly as one embodiment, but the present invention is not limited to this embodiment. Gate valves or gate valve assemblies are commonly used at oil wells in fracturing (frac) operations. Fluids, such as frac fluids, may consist of water or other solutions combined with proppants or frac sand that pass through the gate valve assemblies. Pumps may be used to supply the valves with frac fluid or water. In frac operations, these gate valves may be required to start, adjust, and stop the flow of fluids at pressures of 15,000 psi and higher. In the field, these fluids with the proppants or frac sand may migrate from the valve passageways to cavities within the gate valve assemblies and may degrade the performance of the gate valve assembly. Grease or other materials have been injected to coat the interface surfaces to prevent fluids and proppants from entering, and commonly, the grease or other materials must be applied numerous times to ensure that the proppants or frac sand do not enter the passageways or cavities. However, if the seals of the gate valve assembly were more robust, then this process of applying grease may be limited. Thus, improving the seals of the components of the gate valve assemblies would improve frac operations. Improved seals in the gate valve assemblies would also enable the valve assemblies to be used multiple times without being disassembled, examined, repaired, and reassembled. Further, a data acquisition system may enable the operator to determine if the valve assembly should be disassembled and repaired or if it is working properly.

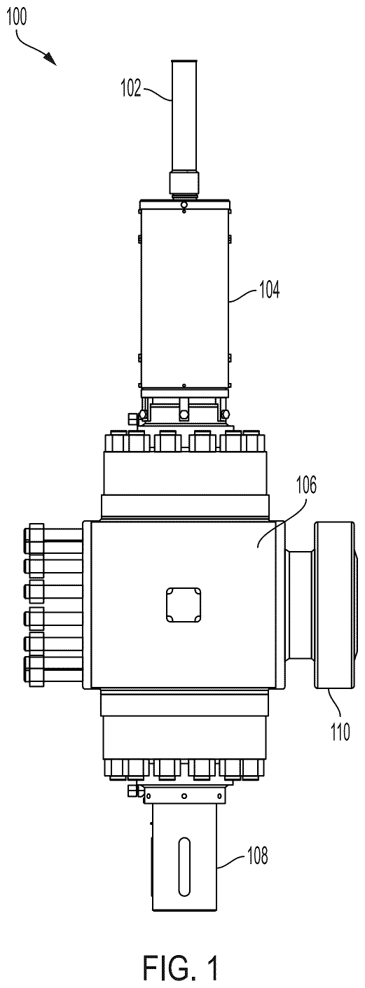

FIG. 1 shows a front view of a traditional gate valve assembly 100. While the figures shown herein relate to valve assemblies used in oil and gas operations, the present invention is not limited to valve assemblies in this industry and may cover valve assemblies used in other operations and industries. Indicator stem protector 102 is attached to a hydraulic cylinder 104 that remotely operates the valve assembly 100. Alternatively, a hand-wheel assembly could do the same. An operating stem (within 104) may be connected to a hand wheel (not shown) to manually open and close the gate valve assembly 100. A body 106 houses the functional portion of the valve and allows the fluid to pass through the gate valve assembly 100. A balance stem protector 108 protects a balance stem (not shown). A flange 110 may be used to connect other valves or pipes to the gate valve assembly 100. A gate (not shown) and a seat assembly (not shown) are located inside the body 106.

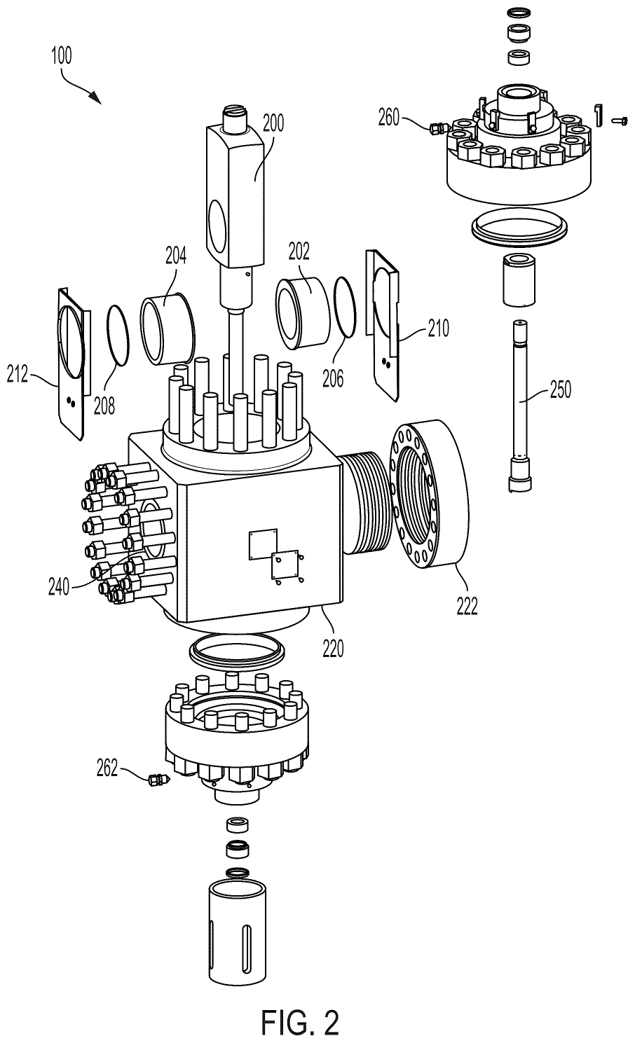

FIG. 2 shows an exploded view of the gate valve assembly 100 with the internal components. Once again, other types of valves are within the scope of the present invention, and the gate valve assembly 100 illustrates a single embodiment of the present invention. A gate 200 fits inside the gate valve assembly 100. An operating stem 250 enables the gate 200 to slide up and down within a body 220 of the gate valve assembly 100 to open and close the valve. Gate guides 210, 212 also protect the gate 200 during operation. The gate 200 connects to the operating stem 250 to enable remote control of the gate 200. For example, routing fluid remotely to hydraulic cylinder 104 will cause the operating stem 250 to push the gate 200 down or up to open or close the gate valve assembly 100. The same action can be created with a hand wheel assembly at the valve assembly. Two seats 202, 204 are located on each side of the gate 200. The gate 200 in conjunction with interface with the seats 202, 204 open and close the passageway within the body 220 of the gate valve assembly 100. Gate guides 210, 212 are also located on each side of the gate 200 to prevent material from entering or exiting the valve cavity as gate 200 opens and closes the valve. Seat seals 206, 208 may be used to seal the interfaces between the seats 202, 204 and seat pockets in valve body 220. In some embodiments, the fluid or water may enter the body 220 through passageway 240. In FIG. 2, the fluid may enter the gate valve assembly 100 through passageway 240 and exit the other side through a flange 222. Fluid into passageway 240 may be considered upstream, while fluid exiting flange 222 may be considered downstream. An upper port 260 and a lower port 262 may provide access to a cavity between the gate 200, the body 220, and the seat assemblies 202, 204. While the upper port 260 and lower port 262 may be used to apply grease to the cavity, it may also be used to obtain measurements within the cavity.

In addition to the gate valve assemblies shown in FIGS. 1 and 2, greaseless gate valve assemblies may be used in the oil and gas industry. Greaseless gate valve assemblies are designed to be used multiple times without disassembly or repair after each stage or use due to the ability of the gate valve assemblies to properly seal off the different cavities within and around the body of the gate valve assembly. For a greaseless valve, the improved sealing mechanism enables the cavities surrounding the flow bore of the valve to retain the grease and keeps the contaminants out of this cavity. With some greaseless valves, the valves may only be disassembled and repaired after a set number of stages or uses. However, this predetermined number of stages or uses is not a reliable method to predict the performance of the greaseless valve. Thus, a method or system to monitor the valve assemblies may assist with operation of traditional valve assemblies and greaseless valve assemblies. Data acquisition of specific variables, such as pressure, load, temperature, and other readings associated with the gate valve assemblies may be used to predict performance of the valves and required maintenance schedules.

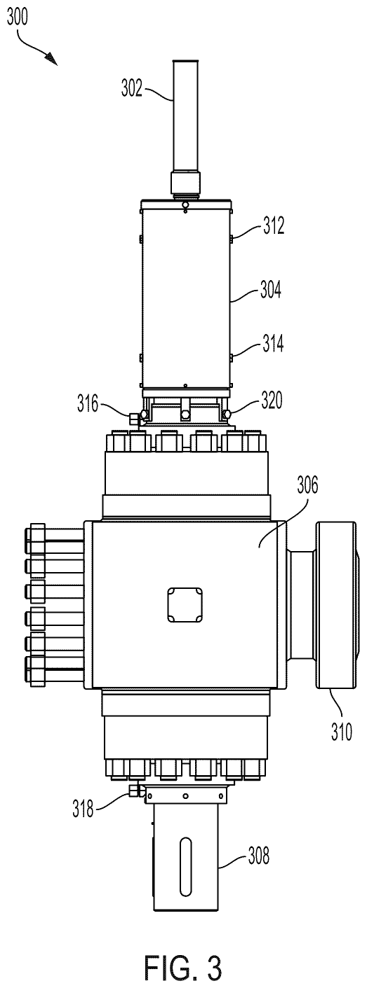

FIG. 3 shows a front view of a gate valve assembly according to certain embodiments of the present invention. The present invention is not limited to greaseless valve assemblies, but FIG. 3 is illustrated as a greaseless valve assembly 300. Indicator stem protector 302 is attached to a hydraulic cylinder 304 that remotely operates the greaseless valve assembly 300. Alternatively, a hand-wheel assembly could do the same. A body 306 houses the functional portion of the valve and allows the fluid to pass through the gate valve assembly 300. A balance stem protector 308 protects a balance stem (not shown). A flange 310 may be used to connect other valves or pipes to the gate valve assembly 300. A gate (not shown) and a seat assembly (not shown) are located inside the body 306. The greaseless valve assembly 300 has two associated cavities, with one surrounding a gate assembly and the seat assemblies, and that other being the cavity (or passageway) where frac fluid flows through. The gate assembly controls the fluid that runs through the passageway of the greaseless valve assembly 300. As discussed above, the greaseless valve assembly 300 is designed to better isolate these two cavities from each other through activation of the seat assemblies. Performance of the greaseless valve assembly 300 and other types of valves depend upon proper activation and deactivation of the seat assemblies, and enabling an operator to monitor these features of the seat assemblies may assist with performance and maintenance.

In certain embodiments, a first hydraulic cylinder sensor (or transducer) 312 and a second hydraulic cylinder sensor (or transducer) 314 may be attached in ports of the hydraulic cylinder 304 to measure the load, pressure, temperature, or other variables inside the hydraulic cylinder 304. A first cavity sensor (or transducer) 316 within an upper port and a second cavity sensor (or transducer) 318 within a lower port may be used to measure pressure, temperature, or other variables within the cavity surrounding the gate assembly and seat assemblies. These sensors 316, 318 may be inserted through existing ports for the injection of grease within the cavity. Additional sensors (or transducers) may be attached to the flow bore of the greaseless valve assembly 300 to measure the flow bore pressure. Comparing the pressures in the cavity with sensors 316, 318 may then be compared to the pressures in the flow bore to determine if the seat assemblies are activated and sealing properly. Depending on position of the gate, isolation of the cavity from the flow bore (shown by different pressures) may suggest proper activation and sealing. There may be minimal and static pressure readings in the cavity for comparison with the flow bore readings that can be dynamic and variable. A first load sensor (or transducer) 320 within a port of the lower portion of the hydraulic cylinder 304 may be used to measure a load on a shaft (i.e., operating stem). Temperature sensors may also be used to assess external and internal temperatures of the valves. Since temperature can affect pressure readings, temperatures should be analyzed along with the pressure readings.

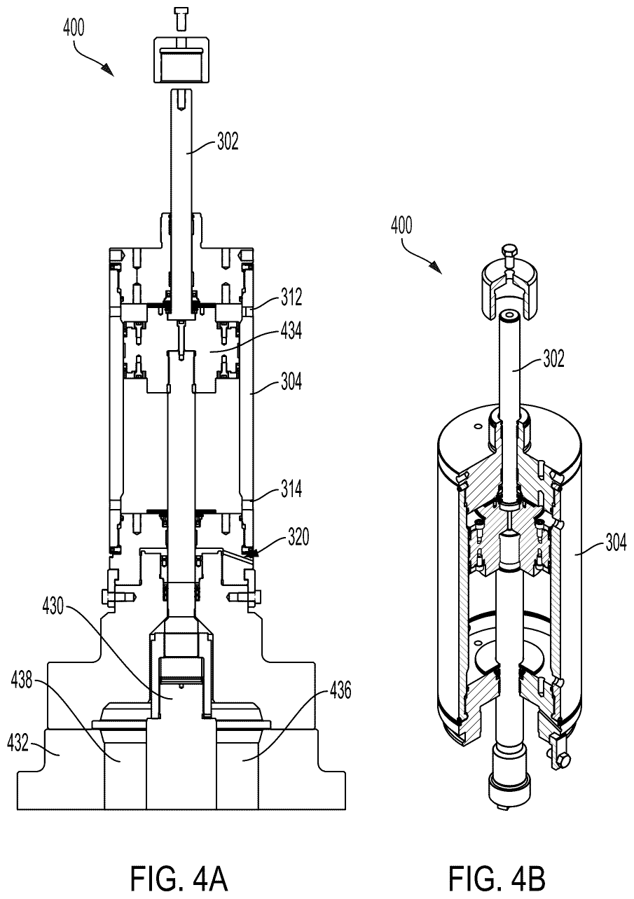

FIGS. 4A and 4B show a cross-section view and an internal view of a hydraulic cylinder assembly 400. The indicator stem 302 is attached to the hydraulic piston 434 that fits into hydraulic cylinder 304. The first hydraulic cylinder sensor 312 and the second hydraulic cylinder sensor 314 may be attached to the hydraulic cylinder 304 through the open and closed ports shown in FIG. 4A. A body of the valve assembly 432 and a gate 430 are also shown in FIG. 4A. Two portions of a cavity 436, 438 surrounds the gate and seat assemblies. Pressures within this cavity 436, 438 may be compared to the pressures within the flow bore according to certain embodiments of the present invention. Pressures from 312 and 314 may be utilized to monitor the functioning of the valve as well. Depending upon the required action of the gate 430 (open or closed), these pressures should predictably fluctuate with baseline pressure readings at the inception of operation of the valve assembly. The pressures on each of these ports should remain in a consistent range based upon these baseline values. The length of hoses, sizes of components, temperatures, and the hydraulic power unit can make these pressure ranges variable, which is why it is critical to establish a baseline at the beginning of operation of the valve assembly and monitor throughout. Abnormal hydraulic feedback pressures in the hydraulic cylinder 400 may indicate additional drag on the gate 430 due to the seat assemblies not deactivating properly.

A first load sensor 320 may be attached at the lower portion of the hydraulic cylinder 400 through the plate. This sensor 320 accurately monitors the load placed upon a shaft within the hydraulic cylinder assembly 400, which is utilized to move the gate 430 back and forth through the seat assemblies. Once again, a baseline should be established at the inception of operation of the valve assembly and the load on the hydraulic cylinder 400 should fluctuate in a consistent range (open and closed) with those baseline values. Abnormal load values for the hydraulic cylinder 400 may indicate drag on the gate 430 due to the seat assemblies not deactivating properly. Outside temperatures at the frac location may affect these pressure and load measurements. Thus, temperature should also be factored into these baseline measurements and should be accounted for in future measurements to ensure that fluctuations are not simply temperature dependent. In some embodiments, these sensors (pressure, load, temperature) may be able to be attached and detached from the valve assembly 300. For example, the sensors may be configured to be inserted through existing ports in the valve assembly 300. This way the valve assembly 300 may be sold or delivered with the ability to adjust, add, or remove the sensors through the ports of the valve assembly 300. Sensors may also be acquired and then configured to fit or operate with existing valve assemblies.

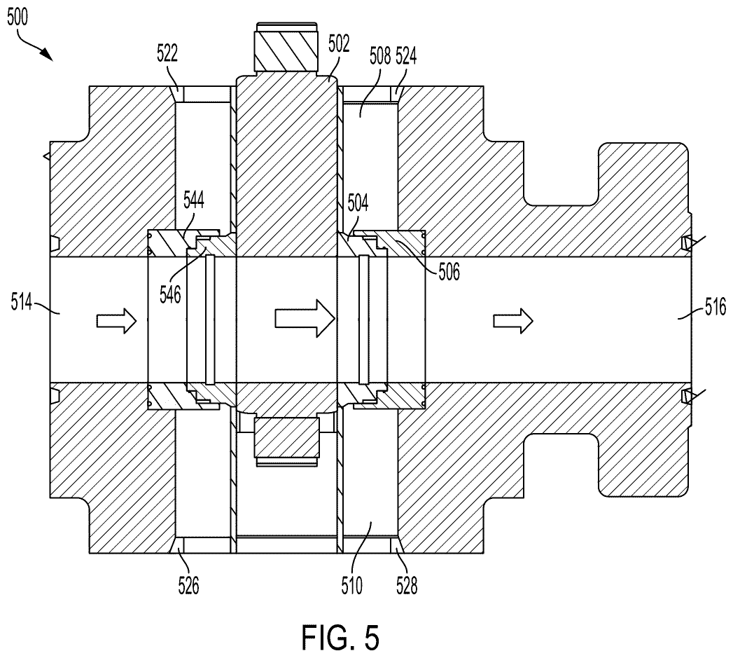

FIG. 5 shows a cross-section view of a greaseless gate valve assembly 500 with the movement of fluids or water through the assembly 500 according to certain embodiments. An arrow shows the movement of the fluids or water from upstream to downstream through the gate valve assembly 500. An upstream portion (cavity) 514 for the movement of fluids and a downstream portion (cavity) 516 are shown in FIG. 5. The gate valve assembly 500 comprises a seat or seat insert 546 and a pocket insert 544 on the upstream side, and a seat or seat insert 504 and a pocket insert 506 on the downstream side. The gate 502 moves up and down to open and close the passageway. In gate valve assembly 500 there are numerous cavities related to gate 502 and seats 504, 546. For example, upper downstream cavity 508 is above seat 504 and lower downstream cavity 510 is below seat 504 (although in three dimensions, these are the same cavity surrounding the gate/seat assembly). In operation, 15,000 psi of fluid with frac sand may be flowing through the passageway 514, 516, while gate 502 may be moving up and down. The seals between gate 502 and seats 504, 546 must be strong and tight to prevent proppants, frac sand, grease, or other materials from entering the cavities 508, 510 in the gate valve assembly 500. In the past, grease has been injected to these areas of the gate valve assembly 500 between operations to ensure that grease, sand, or proppants do not enter the cavities and reduce performance. This takes time and effort and forces the team to take apart and rebuild these portions of the gate valve assembly 500. As shown above numerous components, including numerous seals, make this break down and set up process even more time consuming. This is why valve assemblies need to be disassembled and repaired frequently. By reducing the need to repeatedly disassemble, apply grease to, and repair the gate valve assembly 500 and keeping the cavities 508, 510 clear of sand or other foreign materials, operations at the frac site may be improved. Monitoring of the operation of the gate valve assembly 500 is crucial for this improvement. One or more sensors (or transducers) 522, 524, 526, 528 may be located in ports with access to the cavities 508, 510 to measure pressure, temperature, or other readings. Once again, 508, 510 and other portions of the cavity surrounding the seat assemblies 504, 506, 544, 546 is a single cavity, but 508 and 510 illustrate different portions of this cavity.

As discussed above, the deactivation and activation of the seat assemblies 504, 506, 544, 546 is critical to the movement of the gate 502 to open and close the passageway to control the movement of frac fluid or water through the gate valve assembly 500. In some embodiments, there may be several variables that are monitored through the pressurization and depressurization of the flow bore (upstream 514 and downstream 516). During operation or flow of fluids, the pressures in the cavities 508, 510 should be minimal in comparison to the pressure through the flow bore cavity 514, 516 (the pressures related to the flow bore cavity may be measured at different locations). The pressure in cavities 508, 510 should also remain static and should not fluctuate with the pressures in the flow bore cavity 514, 516. Similar pressures in these two different sections of the greaseless valve assembly 500 may indicate improper activation of one or more of the seat assemblies 504, 506, 544, 546.

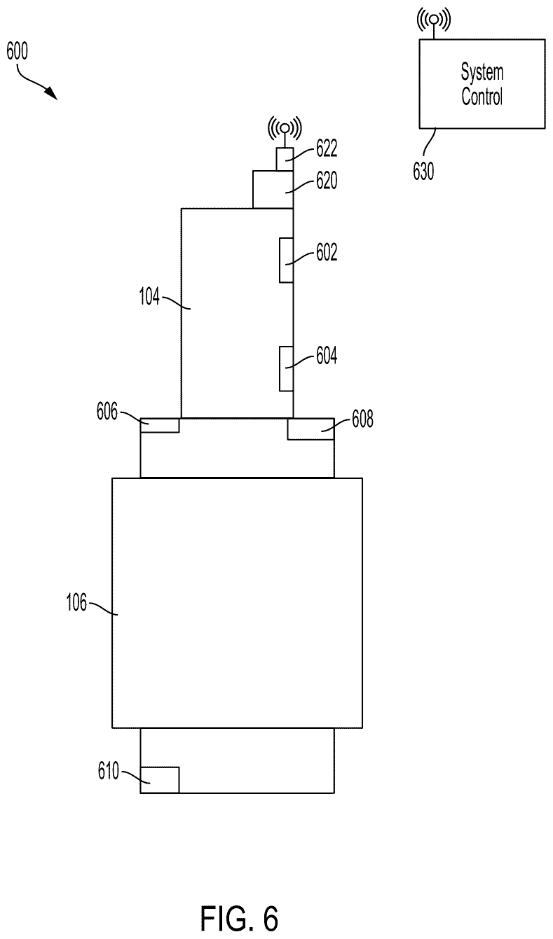

FIG. 6 is a block diagram of a data acquisition system 600 according to certain embodiments of the present invention. The hydraulic cylinder 104 and body 106 of a greaseless gate valve assembly are shown. Hydraulic cylinder pressure sensors 602, 604 and at least one hydraulic cylinder load sensor 608 access pressure and load readings inside of hydraulic cylinder 104. Seat assembly cavity pressure sensors 606 and 610 access pressure readings inside of the cavities that surround the seat assemblies (FIG. 5—508, 510). At least one processor 620 may be installed on the valve 600 to receive, analyze, and prepare for transmission the pressure and load readings from sensors 602, 604, 606, 608, 610. Software may be required to receive, analyze, and prepare for transmission the data from the sensors. A transceiver 622 may also be installed on the valve 600 to communicate with the processor 620 and receive and transmit signals to a system control 630. This system control 630 may be at a remote location and may be controlled by an operator through a computer, mobile device, tablet, website, or other interface between the operator and the system control 630. The processed data from the sensors may be transmitted to the system control 630. Internal and external temperatures may also be captured and transmitted for analysis. Alternatively, the sensors (pressure, load, temperature) may include attached transceivers for transmitting data to the system control 630 or to remote locations. In this embodiment, system control 630 may directly receive the data from the sensors, wherein the processor 620 may not be required for analysis and transmission.

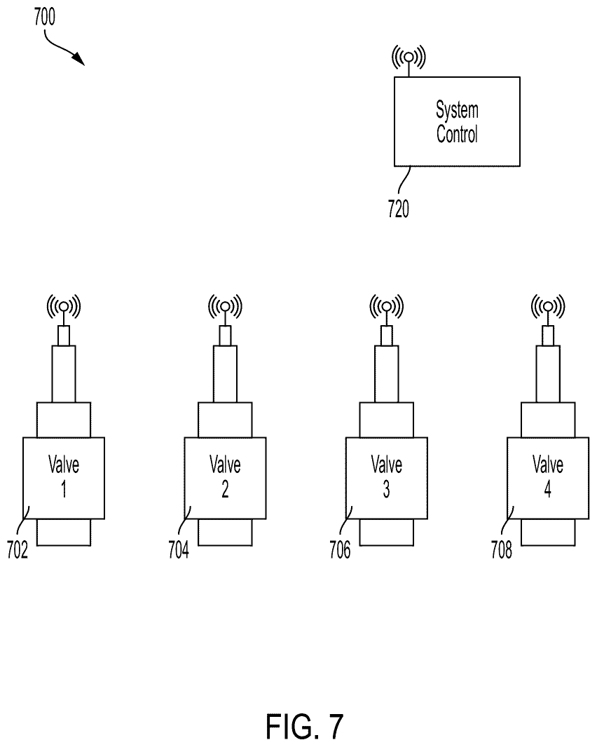

FIG. 7 is a block diagram of a data acquisition system 700 with numerous valves according to certain embodiments of the present invention. In this system 700, there may be more than one valve being monitored. A first valve 702, a second valve 704, a third valve 706, and a fourth valve 708 are similar to the valve shown in FIG. 6. These valves 702, 704, 706, 708 have a processor and a transceiver for communication with a system control 730. The processor may receive, analyze, and prepare for transmission the pressure and load readings from sensors on the valves 702, 704, 706, 708. When multiple valves are being measured at the same time, then differences, deviations, or anomalies within one or more of the numerous valves may be identifiable. For example, a single valve with pressure and/or load measurements that differ from the other valves may indicate that this valve is not operating properly. These valves 702, 704, 706, 708 may control the liquid or frac fluid being applied to numerous wells in numerous stages. Each valve may be use to assist with controlling a stage of a multichannel operation.

The ability to control the valve assemblies and the corresponding sensors through a control system may take many different forms. For example, the data may be uploaded to a website, where an operator can view and manage the valve assemblies through a website portal. The control system may also be offsite with electronic components for wireless reception and transmission onsite to communicate with the various components of the operation. In some embodiments, the control system may simply be a computer or tablet with corresponding software to run the fracturing operation onsite. By moving control of the system to a computer, tablet, website, or remote locations with corresponding computer software, safety may be improved because workers can stay a safe distance away from the operation. Computer software may be used to analyze the sensor readings and present the information to the operator. Computer software may also be used to control the valves in view of the data received from the sensors without human intervention.

As mentioned above, there may be at least three primary parameters or comparisons that are analyzed to determine whether the valve assembly is working properly and may not need to be disassembled and repaired for the next stage or use. The first is an analysis and comparison of the flow bore pressure (514, 516) and the pressure in a cavity surrounding the seat assemblies (508, 510). If the gate/seat seal is properly activating and deactivating, then there should be a difference between the pressure within the flow bore and the pressure within in the cavity, which means that the gate/seat assembly is properly isolating the flow bore from the cavity surrounding the gate and seal assemblies. The corresponding pressure measurements should be analyzed at initial operation to achieve a baseline for the measurements. This allows an operator to determine if the pressures are varying from that baseline, which may indicate a deterioration in the operation of the gate/seat assembly. The pressure in the cavity surrounding the seat assemblies (508, 510) should also retain a minimal pressure value and remain somewhat static through operation. Threshold measurements related to the baseline measurements may be used to indicate that there is an issue with the valve assembly. For example, drift from the baseline measurements by a specific amount (i.e., PSI value change, percentage change) may lead to notifying the operator that there is an issue with the valve assembly.

The second measurements or comparisons may be the pressure readings from the hydraulic cylinder (312, 314). The hydraulic cylinder controls the operation of the gate. If the hydraulic cylinder is properly operating and the gate/seat seal are properly activating and deactivating, then there should be a minimal, consistent, static pressure in the hydraulic cylinder. The pressures may alternate within the hydraulic cylinder based upon the opening and closing of the gate, but the pressures should be predictable. The corresponding pressure measurements should be analyzed at initial operation to achieve a baseline for the measurements that allows an operator to determine if the pressures are varying from that baseline. Differences or variations may indicate a deterioration of the hydraulic cylinder and/or improper operation of the gate/seat assembly.

The third measurements or comparisons may be load measurements from the hydraulic cylinder (320). This sensor accurately monitors the load placed on the hydraulic cylinder assembly, and this alternating load measurement should be predictable from the baseline readings. If the hydraulic cylinder is properly operating and the gate/seat seal are properly activating and deactivating, then the load measurements should be consistent. Differences or variations in these load measurements may indicate a deterioration of the hydraulic cylinder and/or improper operation of the gate/seat assembly.

Pressure and load measurements may be sensitive to outside temperatures and temperatures of the equipment. Thus, temperature readings may be analyzed as well to determine if the pressure or load readings are being affected by external or internal temperatures. For example, pressure readings may deviate depending upon the external or internal temperature without an indication of improper operation. The baseline measurements should be assessed and compared in conjunction with the corresponding temperature measurements. Temperature sensors may be included with the pressure and/or load sensors to provide temperature readings in conjunction with the pressure and load readings. For example, pressure/temperature sensors may be inserted in the ports of the valve assemblies to provide detailed information for analysis.

This disclosure includes additional types of valves that may benefit from acquisition and analysis of pressures, loads, and temperatures. For example, Globe Valves may benefit from load, pressure, and temperature readings to indicate how the valve assembly is operating. Ball Valves may also benefit from load, pressure, and temperature readings to identify if there are any issues with the valve assembly.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A valve assembly comprising:
a valve that allows liquid to flow through a flow bore when the valve is open;
a hydraulic cylinder that is configured to control the valve with a component that is configured to open and close the valve;
a cavity that is configured to surround an area adjacent to the component;
at least one cavity sensor that is configured to measure a first pressure within the cavity;
at least one hydraulic cylinder sensor that is configured to measure a second pressure within the hydraulic cylinder; and
a control system that is configured to analyze the first pressure measurements and the second pressure measurements while the liquid is flowing through the flow bore to determine if the valve assembly is operating properly.

2. The valve assembly of claim 1 wherein said valve assembly is a gate valve assembly and the component is a gate assembly.

3. The valve assembly of claim 2 further comprising at least one hydraulic load sensor that is configured to measure a load on the gate assembly during operation.

4. The valve assembly of claim 3 wherein the control system is further configured to analyze the load measurements on the gate assembly.

5. The valve assembly of claim 1 further comprising a temperature sensor that is configured to measure a temperature related to the valve assembly.

6. The valve assembly of claim 5 wherein the control system is further configured to analyze the temperature measurements in addition to the first pressure readings and second pressure readings.

7. The valve assembly of claim 1 wherein the control system is further configured to establish baseline first pressure measurements and baseline second pressure measurements for comparison to subsequent first pressure measurements and second pressure measurements.

8. The valve assembly of claim 7 wherein the control system is further configured to store threshold first pressure measurements and threshold second pressure measurements related to the baseline measurements for comparison with subsequent first pressure measurements and second pressure measurements.

9. A valve assembly comprising:
a valve that allows liquid to flow through a flow bore when the valve is open;
a cavity that is configured to surround the valve;
a valve sensor that is configured to measure a first pressure of the valve related to the liquid flowing through the valve;
a cavity sensor that is configured to measure a second pressure within the cavity; and
a control system that is configured to analyze the first pressure readings and the second pressure readings while the liquid is flowing through the flow bore to compare changes in the first pressure readings and changes in the second pressure readings.

10. The valve assembly of claim 9 wherein said valve assembly is a gate valve assembly.

11. The valve assembly of claim 10 further comprising a hydraulic cylinder that is configured to control the valve with a component that is configured to open and close the valve, and a hydraulic cylinder sensor that is configured to measure a third pressure within the hydraulic cylinder.

12. The valve assembly of claim 11 wherein the control system is further configured to analyze the third pressure readings and compare changes in the third pressure readings.

13. The valve assembly of claim 9 wherein the control system is further configured to establish baseline first pressure measurements and baseline second pressure measurements for comparison to subsequent first pressure measurements and second pressure measurements.

14. The valve assembly of claim 13 wherein the control system is further configured to store threshold first pressure measurements and threshold second pressure measurements related to the baseline measurements for comparison with subsequent first pressure measurements and second pressure measurements.

15. A valve assembly for use in frac operations to deliver fluid to a well site comprising:
a valve that allows liquid to flow through a flow bore when the valve is open;
a hydraulic cylinder that is configured to control the valve with a component that is configured to open and close the valve;
a valve sensor that is configured to measure a first pressure of the valve related to the liquid flowing through the valve;
a hydraulic cylinder pressure sensor that is configured to measure a second pressure within the hydraulic cylinder;
a hydraulic cylinder load sensor that is configured to measure a first load on the component; and
a control system that is configured to analyze the first pressure readings, the second pressure readings, and the first load readings while the hydraulic cylinder is in operation,
wherein the analysis includes comparing changes in the first pressure readings, and the second pressure readings, and changes in the first load readings.

16. The valve assembly of claim 15 wherein said valve assembly is a gate valve assembly and the component is a gate assembly.

17. The valve assembly of claim 15 further comprising a temperature sensor that is configured to measure a temperature related to the valve assembly.

18. The valve assembly of claim 15 wherein the control system is further configured to analyze the temperature measurements from the temperature sensor in addition to the first pressure readings, second pressure readings, and first load readings.

19. The valve assembly of claim 15 wherein the control system is further configured to establish baseline first pressure measurements and baseline second pressure measurements for comparison to subsequent first pressure measurements and second pressure measurements.

20. The valve assembly of claim 19 wherein the control system is further configured to store threshold first pressure measurements and threshold second pressure measurements related to the baseline measurements for comparison with subsequent first pressure measurements and second pressure measurements.
